(19) United States
(12) Patent Application Publication
(10) Pub. No.: US 2015/0063319 A1
(43) Pub. Date: Mar. 5, 2015

(54) SYSTEMS, METHODS, AND APPARATUS FOR PREVENTING MULTIPLE RE-ASSOCIATION ATTEMPTS

(71) Applicant: QUALCOMM Incorporated, San Diego, CA (US)

(72) Inventors: George Cherian, San Diego, CA (US); Simone Merlin, Solana Beach, CA (US); Santosh Paul Abraham, San Diego, CA (US)

(21) Appl. No.: 14/469,369

(22) Filed: Aug. 26, 2014

Related U.S. Application Data
(60) Provisional application No. 61/871,227, filed on Aug. 28, 2013.

(51) Int. Cl. H04W 48/12; H04W 72/04

(52) U.S. Cl. CPC H04W 48/12; H04W 72/0446; H04W 72/042
USPC 370/336

(57) ABSTRACT

Systems, methods, and devices for wireless communication are described herein. In some aspects, a method for preventing multiple re-association attempts includes identifying a station, determining a back-off period for the identified station during which an access point will reject association requests from the station, and transmitting a message to the station, the message including the determined back-off period. The method may further include rejecting association requests from the identified station during the back-off period. The method may also include determining a timeout period for the identified station after which disassociation with the access point will occur. The message may further include the determined timeout period. The method may also include disassociating the identified station after the timeout period.

### CROSS-REFERENCE TO RELATED APPLICATION

This application claims priority 35 U.S.C. §119(e) to U.S. Provisional Application No. 61/871,227, filed Aug. 28, 2013 and entitled “SYSTEMS, METHODS, AND APPARATUS FOR PREVENTING MULTIPLE RE-ASSOCIATION ATTEMPTS,” the entirety of which is hereby incorporated by reference in its entirety.

### TECHNICAL FIELD

The present application relates generally to wireless communications, and more specifically to systems, methods, and devices for increasing efficiency in wireless communication.

### BACKGROUND

In many telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), or personal area network (PAN). Networks also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, SONET (Synchronous Optical Networking), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc. frequency bands. Wireless networks advantageously facilitate user mobility and rapid field deployment when compared to fixed wired networks.

WLANs use carrier-sense multiple access (CSMA) to share air time for transmission. Efficiency of a WLAN decreases when stations operating at a low data rate, (e.g., at a low modulation coding scheme (MCS) index) require a large amount of time to send a small amount of data when compared to stations operating at a high data rate (e.g., at a high MCS index). Accordingly, systems and methods for improved wireless communication would be beneficial.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

A method for preventing multiple re-association attempts is provided. The method comprises identifying a station. The method further comprises determining a back-off period for the station during which association requests from the station will be rejected. The method further comprises transmitting a message to the station, the message including the back-off period.

An apparatus for wireless communication is also provided. The apparatus comprises a processor configured to identify a station and determine a back-off period for the station during which association requests from the station will be rejected. The apparatus also comprises a transmitter configured to transmit a message to the station, the message including the back-off period.

Another method for preventing multiple re-association attempts is provided. The method comprises receiving a message from an access point, the message including a back-off period during which the access point will reject association requests. The method further comprises refraining from sending association requests to the access point during the back-off period.

Another apparatus for wireless communication is provided. The apparatus comprises a receiver configured to receive a message from an access point, the message including a back-off period during which the access point will reject association requests. The apparatus also comprises a processor configured to refrain from sending association requests to the access point during the back-off period.

### BRIEF DESCRIPTION OF THE DRAWINGS

FIG. 1 shows an example of a wireless communication system in which aspects of the present disclosure may be employed.

FIG. 2 shows various components that may be utilized in a wireless device that may be employed within a wireless communication system.

FIG. 3 shows a call flow diagram of an access point disassociating a station, in accordance with certain embodiments described herein.

FIG. 4 shows a call flow diagram of basic service set transition communications between a station and two access points.

FIG. 5 shows a management frame comprising a frame body.

FIG. 6 shows a frame body comprising a reason code.

FIG. 7 shows a basic service set transition management request frame.

FIG. 8 shows a flow chart of a method for preventing multiple re-association attempts.

FIG. 9 shows a flow chart of another method for preventing multiple re-association attempts.

### DETAILED DESCRIPTION

Various aspects of the novel systems, apparatuses, and methods are described more fully hereinafter with reference to the accompanying drawings. The teachings disclosed herein may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Wireless network technologies may include various types of wireless local area networks (WLANs). A WLAN may be used to interconnect nearby devices together, employing widely used networking protocols. The various aspects described herein may apply to any communication standard, such as WiFi or, more generally, any member of the IEEE 802.11 family of wireless protocols. For example, the various aspects described herein may be used as part of the IEEE 802.11ah, 801.11ac, 802.11n, 802.11g, and/or 802.11b protocols.

In some aspects, wireless signals in a sub-gigahertz band may be transmitted according to the 802.11ah protocol using orthogonal frequency-division multiplexing (OFDM), direct-sequence spread spectrum (DSSS) communications, a combination of OFDM and DSSS communications, or other schemes. Implementations of the 802.11ah protocol may be used for sensors, metering, and smart grid networks. Advantageously, aspects of certain devices implementing the 802.11ah protocol may consume less power than devices implementing other wireless protocols, such as 802.11b and/or 802.11g for example, and/or may be used to transmit wireless signals across a relatively long range, for example about one kilometer or longer.

Certain of the devices described herein may further implement Multiple Input Multiple Output (MIMO) technology. This may also be implemented as part of the 802.11ah standard. A MIMO system employs multiple (NT) transmit antennas and multiple (NR) receive antennas for data transmission. A MIMO channel formed by the NT transmit and NR receive antennas may be decomposed into NS independent channels, which are also referred to as spatial channels or streams. Each of the NS independent channels corresponds to a dimension. The MIMO system can provide improved performance (e.g., higher throughput and/or greater reliability) if the additional dimensionalities created by the multiple transmit and receive antennas are utilized.

In some implementations, a WLAN includes various devices which are the components that access the wireless network. For example, there may be two types of devices: access points (APs) and stations (STAs). In general, an AP serves as a hub or base station for the WLAN and an STA serves as a user of the WLAN. For example, an STA may be a laptop computer, a personal digital assistant (PDA), a mobile phone, etc. In an example, an STA connects to an AP via a WiFi (e.g., IEEE 802.11 protocol such as 802.11ah) compliant wireless link to obtain general connectivity to the Internet or to other wide area networks. In some implementations an STA may also be used as an AP.

An AP may also comprise, be implemented as, or known as a NodeB, Radio Network Controller (RNC), eNodeB, Base Station Controller (BSC), Base Transceiver Station (BTS), Base Station (BS), Transceiver Function (TF), Radio Router, Radio Transceiver, or some other terminology.

An STA may also comprise, be implemented as, or known as an access terminal (AT), a subscriber station, a subscriber unit, a mobile station, a remote station, a remote terminal, a user terminal, a user agent, a user device, user equipment, or some other terminology. In some implementations an AT may comprise a cellular telephone, a cordless telephone, a Session Initiation Protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a PDA), an entertainment device (e.g., a music or video device, or a satellite radio), a gaming device or system, a global positioning system device, or any other suitable device that is configured to communicate via a wireless medium.

As discussed above, certain of the devices described herein may implement the 802.11ah standard, for example. Such devices, whether used as an STA, an AP, or other device, may be used for smart metering or in a smart grid network. Such devices may provide sensor applications or be used in home automation. The devices may instead or in addition be used in a healthcare context, for example for personal healthcare. They may also be used for surveillance, to enable extended-range Internet connectivity (e.g. for use with hotspots), or to implement machine-to-machine communications.

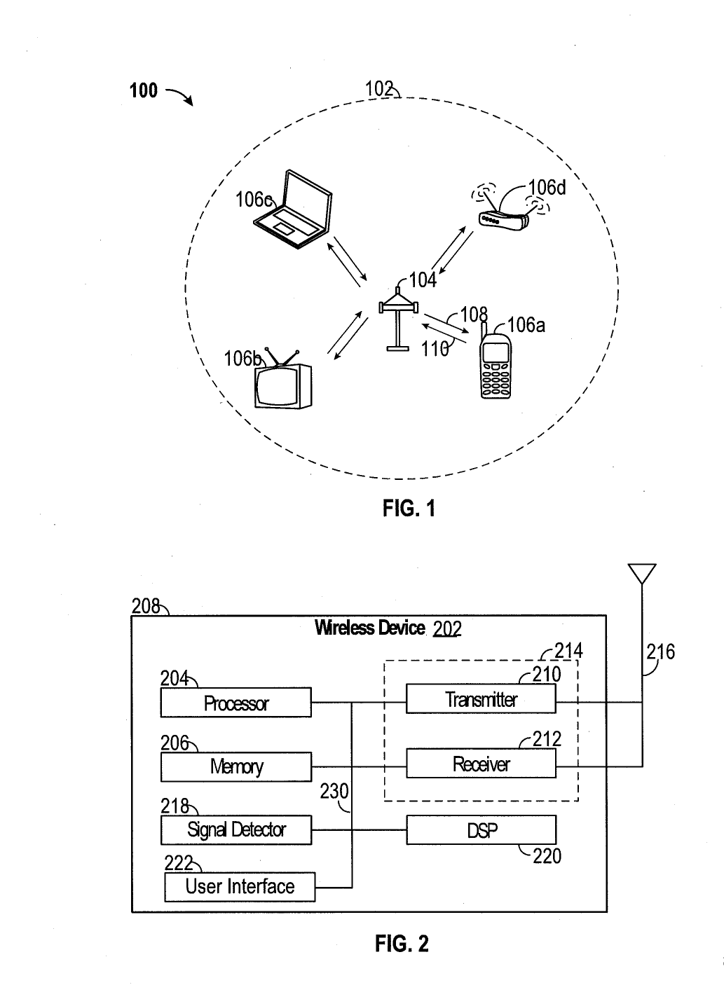

FIG. 1 shows an example of a wireless communication system 100 in which aspects of the present disclosure may be employed. The wireless communication system 100 may operate pursuant to a wireless standard, for example at least one of the 802.11ah, 802.11ac, 802.11n, 802.11g and 802.11b standards. The wireless communication system 100 may include an AP 104, which may communicate with one or more STAs 106.

A variety of processes and methods may be used for transmissions in the wireless communication system 100 between the AP 104 and the STAs 106. For example, signals may be transmitted and received between the AP 104 and the STAs 106 in accordance with OFDM/OFDMA techniques. If this is the case, the wireless communication system 100 may be referred to as an OFDM/OFDMA system. Alternatively, signals may be transmitted and received between the AP 104 and the STAs 106 in accordance with CDMA techniques. If this is the case, the wireless communication system 100 may be referred to as a CDMA system.

A communication link that facilitates transmission from the AP 104 to one or more of the STAs 106 may be referred to as a downlink (DL) 108. A communication link that facilitates transmission from one or more of the STAs 106 to the AP 104 may be referred to as an uplink (UL) 110. Alternatively, a DL 108 may be referred to as a forward link or a forward channel, and a UL 110 may be referred to as a reverse link or a reverse channel.

The AP 104 may provide wireless communication coverage in a basic service area (BSA) 102. The AP 104 along with the STAs 106 associated with the AP 104 and that use the AP 104 for communication may be referred to as a basic service set (BSS). It should be noted that the wireless communication system 100 may not have a central AP 104, but rather may function as a peer-to-peer network between the STAs 106. Accordingly, the functions of the AP 104 described herein may alternatively be performed by one or more of the STAs 106.

FIG. 2 shows various components that may be utilized in a wireless device 202 that may be employed within the wireless communication system 100. The wireless device 202 is an example of a device that may be configured to implement the various methods described herein. For example, the wireless device 202 may be configured as the AP 104 or as one of the STAs 106. The wireless device 202 may comprise a housing 208 for enclosing at least some of the components of the wireless device 202.

The wireless device 202 may comprise a communication bus 230 which may be coupled to each component of the wireless device 202. The communication bus 230 may be configured to enable communication of data and signals between the components of the wireless device 202. The communication bus 230 may comprise a data bus, for example, as well as a power bus, a control signal bus, and a status signal bus in addition to the data bus. Those of skill in the art will appreciate the components of the wireless device 202 may be coupled together or accept or provide inputs to each other using some other mechanism.

The wireless device 202 may also comprise a processor 204 coupled to the communication bus 230. The processor 204 may control the operations of each component of the wireless device 202. The processor 204 may also be referred to as a central processing unit (CPU). The wireless device 202 may also comprise a memory unit 206 coupled to the communication bus 230. The memory unit 206 may comprise read-only memory (ROM) and/or random access memory (RAM), and may provide instructions and data to the processor 204. A portion of the memory unit 206 may also include non-volatile random access memory (NVRAM). The processor 204 may perform logical and arithmetic operations based on program instructions stored within the memory unit 206. The instructions stored in the memory unit 206 may be executable to implement the methods described herein.

The processor 204 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 202 may also comprise a transmitter 210 and a receiver 212, both of which are coupled to communication bus 230. The transmitter 210 and the receiver 212 may be configured to allow transmission and reception of data between the wireless device 202 and a remote location. The transmitter 210 and receiver 212 may be combined into a transceiver 214. The wireless device 202 may also comprise an antenna 216 which may be attached to the housing 208 and coupled to the transceiver 214. The wireless device 202 may also include (not shown) multiple transmitters, multiple receivers, multiple transceivers, and/or multiple antennas, which may be utilized during MIMO communications, for example.

The wireless device 202 may also comprise a signal detector 218 coupled to the communication bus 230. The signal detector 218 may be used in an effort to detect and quantify the level of signals received by the transceiver 214. The signal detector 218 may detect such signals as total energy, energy per subcarrier per symbol, power spectral density and other signals. The wireless device 202 may also comprise a DSP 220 coupled to the communication bus 230. The DSP 220 may be used for processing signals. The DSP 220 may be configured to generate a data unit for transmission. In some aspects, the data unit may comprise a physical layer data unit (PPDU). In some aspects, the PPDU is referred to as a packet.

The wireless device 202 may further comprise a user interface 222 in some aspects. The user interface 222 may comprise a keypad, a microphone, a speaker, and/or a display. The user interface 222 may include any element or component that conveys information to a user of the wireless device 202 and/or receives input from the user.

Although a number of separate components are illustrated in FIG. 2, those of skill in the art will recognize that one or more of the components may be combined or commonly implemented. For example, the processor 204 may be used to implement not only the functionality described above with respect to the processor 204, but also to implement the functionality described above with respect to the signal detector 218 and/or the DSP 220. Further, each of the components illustrated in FIG. 2 may be implemented using a plurality of separate elements.

As discussed above, the wireless device 202 may comprise an AP 104 or an STA 106, and may be used to transmit and/or receive communication. The communications exchanged between devices in a wireless network may include data units which may comprise packets or frames. In some aspects, the data units may include data frames, control frames, and/or management frames. Data frames may be used for transmitting data from an AP and/or an STA to other APs and/or STAs. Control frames may be used together with data frames for performing various operations and for reliably delivering data (e.g., acknowledging receipt of data, polling of APs, area-clearing operations, channel acquisition, carrier-sensing maintenance functions, etc.). Management frames may be used for various supervisory functions (e.g., for joining and departing from wireless networks, etc.).

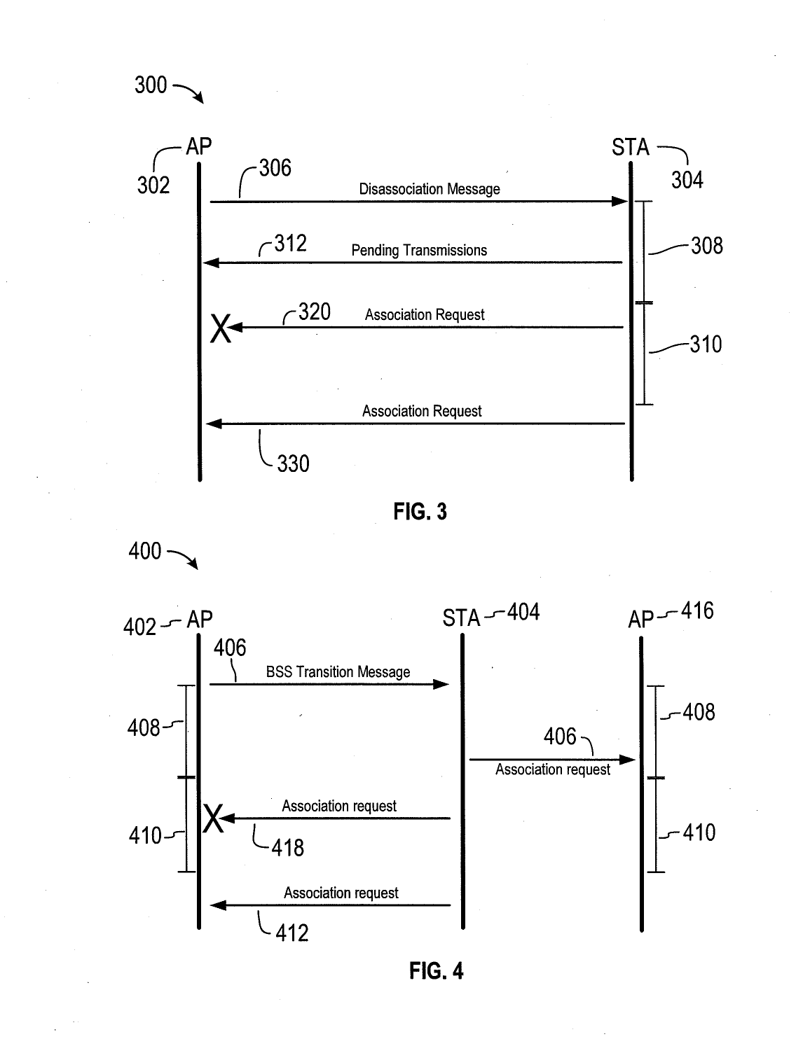

FIG. 3 shows a call flow diagram 300 of an AP 302 disassociating an STA 304, in accordance with an exemplary embodiment. In the call flow diagram 300, calls occurring earlier in time are shown vertically above calls occurring later in time. The AP 302 may be configured as the AP 104 of FIG. 1 and the STA 304 may be configured as the STA 106 of FIG. 1. As described above, the AP 302 and the STA 304 may communicate with each other over a wireless protocol. In some embodiments, in order to establish communication between the AP 302 and the STA 304, the STA 304 may request association with the AP 302 and the AP 302 may acknowledge the STA's 302 association request. The AP 302 may disassociate the STA 304 to cease communication with the STA 304.

As described above, an STA operating at a lower MCS may require a larger amount of time to send a set amount of data compared to an STA operating at a higher MCS. As such, an STA operating at a lower MCS compared to other STAs associated to one AP may lower the overall wireless communication efficiency of the AP. In order to increase wireless communication efficiency the AP may identify an STA operating a low MCS and may disassociate that STA from the AP. The AP may identify the STA based on a threshold MCS index or based on a difference between the MCS index of the identified STA and the MCS indexes of other associated STAs.

In FIG. 3, the STA 304 may be associated with the AP 302. The AP 302 may determine an acceptable MCS range based on its channel usage. The AP 302 may re-determine its acceptable MCS range over time. The AP 302 may determine that the STA 304 is operating at an MCS that lower than the acceptable range. The STA 304 may be using a longer amount of air time to transmit data compared to other STAs associated with the AP 302. The AP 302 may send a disassociation message 306 to STA 304 to disassociate the STA 304. The dissociation message 306 may comprise a reason code indicating that the STA 304 is operating at a low MCS. In some embodiments, the disassociation message 306 may comprise a management frame of type disassociation and may comprise a reason code field indicating a low MCS. The AP 302 may also indicate to the STA 304 an MCS range that is acceptable and would not result in the AP 302 disassociating the STA 304. In some embodiments, the STA 304 may be able to increase its MCS and may indicate the increase MCS to the AP 302 to avoid disassociation.

The disassociation message 306 may also indicate a timeout period 308 after which the AP 302 may disassociate the STA 304. During the timeout period 308, the STA 304 may communicate with the AP 302. For example, the STA 304 may transmit pending transmissions 312 and may also request information in preparation for the disassociation. The timeout period 308 is beneficial because immediate disconnection of the STA 304 may disrupt user applications of the STA 304. During the timeout period 308, the STA 304 may be able to associate with another AP to maintain wireless communication with a network. For example, the STA 304 may send an association request to another AP in the same cell area. In some embodiments, the STA 304 may not send a request for association to another AP and may instead listen for a beacon or other transmission from another AP in response to receiving the disassociation message 306. In some embodiments, the AP 302 may aid the STA 304 with synchronization and discovery functions for the STA 304 to associate with another AP in the network. As described above, after the timeout period 308, the AP 302 may disassociate the STA 304. The disassociation may occur at the end of the timeout period 308 or after a period of time after the end of the timeout period 308.

The disassociation message 306 sent from the AP 302 to the STA 304 may also indicate a back-off period 310 during which the AP 302 will reject association requests from the STA 304. In some embodiments, the AP 302 may provide the back-off period 310 to the STA 304 as a separate message. As shown in FIG. 3, the back-off period 310 may begin adjacent in time with the end of the timeout period 308. In some embodiments, the back-off period 310 may begin an amount of time after the end of the timeout period 308.

The AP 302 may store a list of the MAC addresses for STAs that are disassociated along with a corresponding list back-off periods for each STA. As shown in FIG. 3, the STA 304 may transmit an association request 320 to the AP 302 during the back-off period 310. The AP 302 may determine that the STA 302 was previously disassociated from the AP 302 and assigned the back-off period 310. The AP 302 may determine that the association request 320 was received within the back-off period 310 and the AP 302 may reject the association request 320. The AP 302 may respond to the association request 320 with an association response frame having a status code of “reject.” In some embodiments, the association response frame from the AP 302 may also indicate a second back-off period for preventing association requests from the STA 304. After the back-off period 310 has ended, the AP 302 may accept an association request 312 from the STA 304. The STA 304 may send an association request 330 after the back-off period 310 has expired. The AP 302 may accept the association request 330 or it may deny the association request based on an MCS of the STA 304 as described above.

In some embodiments, the timeout period 308 and the back-off period 310 may vary over time for the same STA 304 or may be different for different STAs communicating with the same AP 302. For example, the AP 302 may provide a first timeout period 308 before disassociating the STA 304 and a second, different timeout period (not shown) to disassociate the same STA 304 after the STA 304 has re-associated with the AP 302. In other embodiments, the timeout period 308 and the back-off period 310 may remain fixed over a period of time or consistent for STAs communicating with the same AP 302. In some embodiments, the disassociation message 306 may only comprise the timeout period 308 and not the back-off period 310.

The AP 302 may also provide a back-off period in response to a probe request from the STA 304. The AP 302 may determine that the STA 304 is operating at an MCS that is below the acceptable MCS range of the AP 302 and the AP 302 may respond to the probe request from the STA 304 with a probe rejection indicating a back-off period during which the STA 304 may not send any further probe requests to the AP 302. The AP 302 may also provide a reason code to the STA 304 indicating a low MCS. The AP 302 may also indicate the acceptable MCS range to the STA 304.

The AP 302 may also provide a back-off period in response to an authentication request from an STA 302. The AP 302 may determine that the STA 304 is operating at an MCS that is below the acceptable MCS range of the AP 302 and the AP 302 may respond to the authentication request with an authentication rejection indicating a back-off period during which the STA 304 may not send any further authentication requests to the AP 302. The AP 302 may also provide a reason code to the STA 304 indicating a low MCS. The AP 302 may also indicate the acceptable MCS range to the STA 304.

FIG. 4 shows a call flow diagram 400 of BSS transition communications between an STA 404 and two APs 402 and 416. In the call flow diagram 400, calls occurring earlier in time are shown vertically above calls occurring later in time. The first AP 402 may be configured as the AP 104 of FIG. 1, the second AP 416 may also be configured as the AP 104 of FIG. 1. The STA 304 may be configured as the STA 106 of FIG. 1. Before the call flow exchange of FIG. 4 occurs, the STA 404 may be associated with the first AP 402. As such, the STA 404 may be part of a BSS of the first AP 402. In this embodiment, the first AP 402 may identify the STA 404 to transition to a second AP's 416 BSS. The STA 404 may be operating at a lower efficiency level (e.g., a lower MCS) compared to other STAs that are being serviced by the first AP 402. As such, the STA 404 may be negatively impacting the overall transmission efficiency of the first AP 402. The AP 402 may determine an acceptable MCS range for associated STAs based on its channel usage. The first AP 402 may identify the STA 404 to transition to another BSS based on an MCS of the STA 404 being below the acceptable MCS range.

In order to transfer the STA 404, the first AP 402 may transmit a BSS transition message 406 to the STA 404 indicating for the STA 404 to transfer to the second AP's 416 BSS within a specified timeout period 408. The STA 404 may transmit any pending transmission (not shown) to the AP 402 during the timeout period 408. In one embodiment, the BSS transition message 406 may include an identifier of the STA 404. The BSS transition message 406 may also indicate a back-off period 410 during which the first AP 402 will refuse any further association requests from the STA 404. The beginning of the back-off period 410 may occur adjacent in time to the end of the timeout period 408. As shown in FIG. 4, the AP 402 may refuse or ignore an association request 418 from the STA 404 during the back-off period 410. In response to receiving the BSS transition message, the STA 404 may send an association request 406 to the second AP 416. The STA 404 may send the association request 406 to the AP 416 during the timeout period 408. The STA 404 may also send the association request 406 to the AP 416 after the timeout period. In some embodiments, the AP 402 may provide to STA 404 a reason for the BSS transition message being sent (e.g., due to the MCS that is being used by the STA 404). The AP 402 may accept an association request 412 from the STA 404 sent after the back-off period 410.

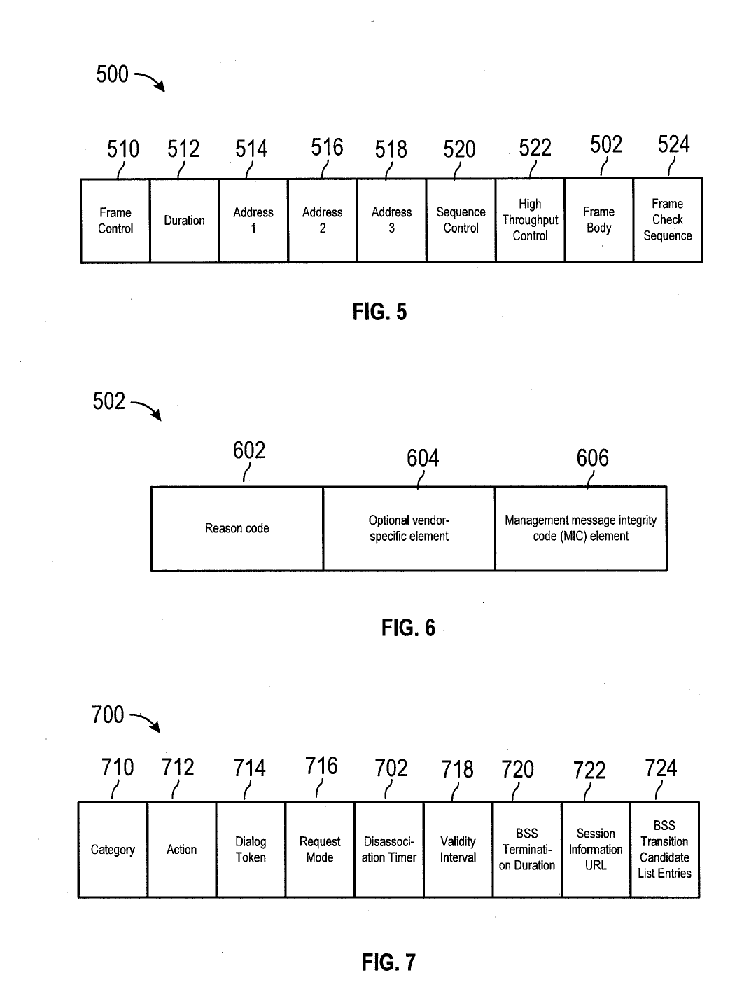

FIG. 5 shows a management frame 500 comprising a frame body 502. In some embodiments, the management frame 500 may comprise fields such as a frame control field 510, a duration field 512, an address 1 field 514, an address 2 field 516, an address 3 field 518, a sequence control field 520, a high throughput control field 522, frame body 502, and a frame check sequence field 524. The disassociation message 306 of FIG. 3 may be a management frame 500. In another embodiment, the BSS transition management request 406 of FIG. 4 may be a management frame 500.

FIG. 6 shows the frame body field 502 of the management frame 500 of FIG. 5. In some embodiments, the frame body 502 may comprise a reason code field 602, an optional vendor-specific element field 604, and a management message integrity code element field 606. The disassociation message 306 of FIG. 3 may indicate a reason code in the reason code field 602 of a management frame.

FIG. 7 shows a BSS transition management request frame 700, in accordance with an exemplary embodiment. The BSS transition management request frame 700 may contain fields such as a category field 710, an action field 712, a dialog token field 714, a request mode field 716, a disassociation timer field 702, a validity interval field 718, a BSS termination duration field 720, a session information URL field 722, and a BSS transition candidate list entries field 724. The BSS transition message request 406 of FIG. 4 may indicate a timeout period in the disassociation timer field 702.

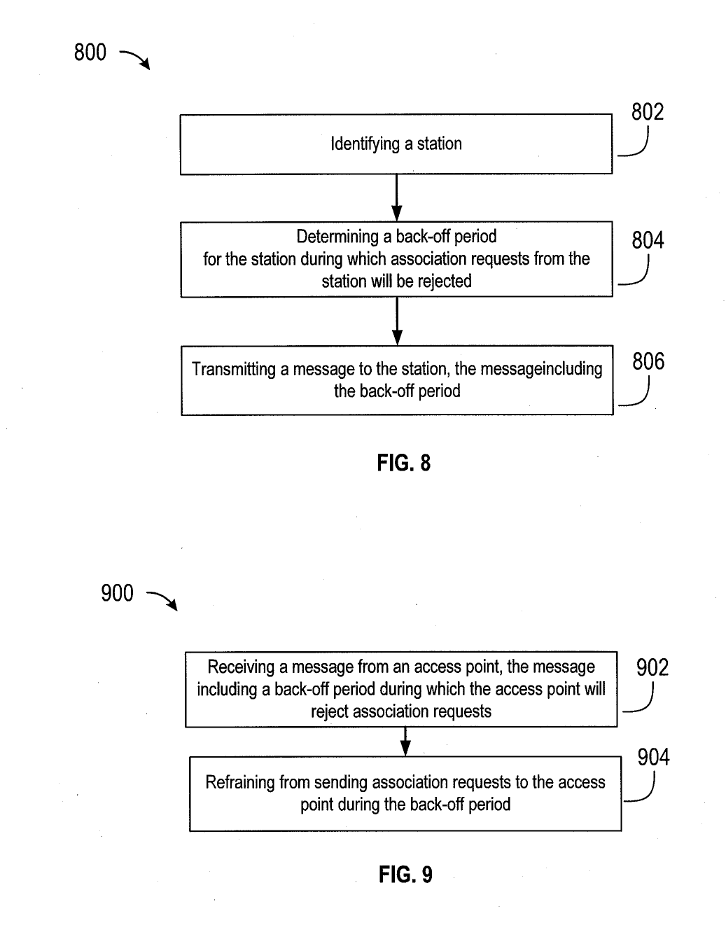

FIG. 8 shows a flow chart 800 of a method for preventing multiple re-association attempts, in accordance with an exemplary embodiment. Before the start of the method, an STA may be associated with an AP as described above. At block 802, the method may identify an STA. At block 804, the method may determine a back-off period for the STA during which association requests from the STA will be rejected. At block 806, the method may transmit a message to the STA, the message including the back-off period.

FIG. 9 shows a flow chart 900 of another method for preventing multiple re-association attempts, in accordance with an exemplary embodiment. Before the start of the method, an STA may be associated with an AP, as described above. At block 902 the method may receive a message from an AP, the message including a back-off period during which the AP will reject association requests. As described above, the message may be sent by the AP due to the fact that the STA is operating at a lower efficiency level, e.g., is encoding data at a lower MCS, than other STAs that are being serviced by the AP and is thereby negatively impacting the overall efficiency of the AP. At step 904 the method may refrain from sending association requests to the AP during the back-off period.

A person/one having ordinary skill in the art would understand that information and signals can be represented using any of a variety of different technologies and techniques. For example, data, instructions, commands, information, signals, bits, symbols, and chips that can be referenced throughout the above description can be represented by voltages, currents, electromagnetic waves, magnetic fields or particles, optical fields or particles, or any combination thereof.

Various modifications to the implementations described in this disclosure can be readily apparent to those skilled in the art, and the generic principles defined herein can be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations.

Certain features that are described in this specification in the context of separate implementations also can be implemented in combination in a single implementation. Conversely, various features that are described in the context of a single implementation also can be implemented in multiple implementations separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a DSP, an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

While the foregoing is directed to aspects of the present disclosure, other and further aspects of the disclosure may be devised without departing from the basic scope thereof, and the scope thereof is determined by the claims that follow.

What is claimed is:

1. A method for preventing multiple association requests, comprising:
identifying a station;
determining a back-off period for the station during which association requests from the station will be rejected; and
transmitting a message to the station, the message including the back-off period.

2. The method of claim 1, further comprising determining a modulation and coding scheme range for associated stations.

3. The method of claim 2, wherein the modulation and coding scheme range for associated stations is adjusted based on channel usage of the associated stations.

4. The method of claim 2, wherein the modulation and coding scheme range for associated stations is based on modulation and coding schemes of the associated stations.

5. The method of claim 2, wherein the station is identified based on a modulation and coding scheme index of the station being below the modulation and coding scheme range.

6. The method of claim 1, further comprising rejecting an association request from the identified station during the back-off period.

7. The method of claim 1, wherein the station is identified based on a media access control address of the station.

8. The method of claim 1, further comprising determining a timeout period for the identified station after which the station will be disassociated, wherein the message further includes the timeout period.

9. The method of claim 8, further comprising receiving transmissions from the identified station during the timeout period.

10. The method of claim 8, further comprising disassociating the identified station after the timeout period.

11. The method of claim 1, wherein the message further includes a request for the station to change basic service sets.

12. An apparatus for wireless communication, comprising:
a processor configured to identify a station and determine a back-off period for the station during which association requests from the station will be rejected; and
a transmitter configured to transmit a message to the station, the message including the back-off period.

13. The apparatus of claim 12, wherein the processor is further configured to determine a modulation and coding scheme range for associated stations.

14. The apparatus of claim 13, wherein the modulation and coding scheme range for associated stations is adjusted based on channel usage of the associated stations.

15. The apparatus of claim 13, wherein the modulation and coding scheme range for associated stations is based on modulation and coding schemes of the associated stations.

16. The apparatus of claim 13, wherein the processor is further configured to identify the station based on a modulation and coding scheme index of the station being below the modulation and coding scheme range.

17. The apparatus of claim 12, wherein the processor is further configured to reject an association request from the identified station during the back-off period.

18. The apparatus of claim 12, wherein the processor is further configured to identify the station based on a media access control address of the station.

19. The apparatus of claim 12, wherein the processor is further configured to determine a timeout period for the identified station after which the station will be disassociated and the message further includes the timeout period.

20. The apparatus of claim 19, further comprising receiving transmissions from the identified station during the timeout period.

21. The apparatus of claim 19, wherein the processor is further configured to disassociate the identified station after the timeout period.

22. The method of claim 12, wherein the message further includes a request for the station to change basic service sets.

23. A method for preventing multiple association requests, comprising:
receiving a message from an access point, the message including a back-off period during which the access point will reject association requests; and
refraining from sending association requests to the access point during the back-off period.

24. The method of claim 23, wherein the message further includes a reason code indicating the message was generated due to a modulation coding scheme of the station being below a modulation and coding scheme range.

25. The method of claim 23, wherein the message further includes a timeout period after which disassociation with the access point will occur.

26. The method of claim 23, wherein the message further includes a request to transition to another basic service set.

27. An apparatus for wireless communication, comprising:
a receiver configured to receive a message from an access point, the message including a back-off period during which the access point will reject association requests from the station; and
a processor configured to refrain from sending association requests to the access point during the back-off period.

28. The apparatus of claim 27, wherein the message further includes a reason code indicating the message was generated due to a modulation coding scheme of the station being below a modulation and coding scheme range.

29. The apparatus of claim 27, wherein the received message further includes a timeout period after which disassociation with the access point will occur.

30. The apparatus of claim 27, wherein the processor is further configured to change basic service sets in response to receiving the request.
